(19) United States
(12) Patent Application Publication
(10) Pub. No.: US 2009/0043015 A1
(43) Pub. Date: Feb. 12, 2009

(54) Light-Weight Molding Material

(75) Inventor: Toshiyuki Yamamuro, Yokohama-shi (JP)

Correspondence Address: KANESAKA BERNER AND PARTNERS LLP, 1700 DIAGONAL RD, SUITE 310, ALEXANDRIA, VA, 22314-2848, US

(73) Assignee: INFUA CO., LTD., Yokohama-shi ,Kanagawa -ken (JP)

(21) Appl. No.: 12/084,049

(22) PCT Filed: Nov. 9, 2006
(86) PCT No.: PCT/JP2006/322330

§ 371 Date: Apr. 24, 2008

(30) Foreign Application Priority Data
Nov. 14, 2005 (JP) 2005-328416

(51) Int. Cl. C08L 29/04; C08K 5/09; C08K 5/36; C08L 5/00

(52) U.S. Cl. 524/27; 524/557; 524/300; 524/155

(57) ABSTRACT

There is provided a creamy light-weight molding material which has good fluidity to be readily squeezed, provides excellent shape retentivity, and provides excellent storage stability.

The light-weight molding material is composed of a binder resin containing a polyvinyl alcohol resin, a viscosity adjusting agent, water, and a light-weight material, wherein the light-weight material content is from 3 to 22% by weight, and the water content is from 65 to 92%, and a mixing ratio (weight ratio) of water to the polyvinyl alcohol resin is from 3 to 300.

### BACKGROUND OF THE INVENTION

1. Field of the Invention

The present invention relates to a light-weight molding material, and specifically to a creamy light-weight molding material providing high fluidity and excellent shape retentivity. More specifically, the light-weight molding material of the present invention has a wide range of applications such as backing materials for frescoes, oil painting, or watercolor painting, materials for plastic models of confection, and ornament materials.

2. Description of the Related Art

In the technical fields such as the production of ornament materials, there have been no light-weight molding materials with ease of use, so that easily-available clays have been used as makeshifts.

However, conventional clays are heavy and inconvenient to use because most of them are composed mainly of granular materials or plant residue segments, and additives such as binders for binding granular materials, fragrant materials, dyes, moisture, and oils.

In order to solve these problems, proposed is a light-weight clay providing ease of incineration, wherein the clay is composed of 3 to 20% by weight of organic microballoon having copolymer shells containing acrylonitrile or vinylidene chloride, 5 to 20% by weight of a synthetic binder (carboxymethyl cellulose), 10 to 30% by weight of a fiber powder, and 50 to 60% by weight of water with reference to the total weight (for example, see Patent Document 1).

The proportion of water in the light-weight clay is strictly defined. This is because if the proportion of water is below 50% by weight, molding of the clay becomes difficult, while if above 60% by weight, the clay is softened to provide poor moldability, and loses lightness.

Also proposed is a light-weight clay which will not be cracked, bent, or broken even if it is deformed by an external force after being molded and dried, and thus allows long-term storage. (for example, see Patent Document 2).

More specifically, the light-weight clay is composed mainly of synthetic resin microballoon having a particle size of 20 to 120 μm (5 to 15% by weight), a polyvinyl alcohol resin (5 to 10% by weight), a vinyl acetate resin, and water (50 to 80% by weight), wherein a weight ratio between the polyvinyl alcohol resin and the vinyl acetate resin is from 10:7 to 10:3.

Also proposed is a light-weight clay providing remarkable deformation resistance during drying, and excellent physical properties such as workability and texture when used as a clay for handicraft or the like (for example, see Patent Document 3).

More specifically, the light-weight clay for molding is composed of 5 to 15% by weight of synthetic resin microballoon having a particle size of 20 to 120 μm, 5 to 10% by weight of a polyvinyl alcohol resin, 1.5 to 7% by weight of a vinyl acetate resin containing a plasticizer, 0.5 to 1.5% by weight of polyethylene oxide, and 50 to 80% by weight of water.

Also proposed is a light-weight clay containing the organic microballoon, wherein an average particle size of organic microballoon is adjusted to a value within the range of from 30 to 150 μm, an addition quantity of the microballoon is adjusted to a value within the range of 0.1% or more and below 3% by weight with reference to the total amount, and an addition quantity of the water is adjusted to a value within the range of from 65 to 85% by weight with reference to the total amount (for example, see Patent Document 4).

On the other hand, a tube clay is proposed, wherein the clay is flowable and very easy to squeeze out from the tube while keeping hands and fingers clean, and provides great convenience of use (for example, see Patent Document 5).

More specifically, as shown in FIG. 8, proposed is a clay 102 contained in a tube container, the clay being composed of a flowable clay (not shown) filled in a soft tube container 100 with a cap 103, wherein the clay is squeezed out from the tube container 100.

[Patent Document 1] JPH02-123390A (Claims and others)
[Patent Document 2] JP2001-131329A (Claims and others)
[Patent Document 3] JP2001-234081A (Claims and others)
[Patent Document 4] JP2002-356365A (Claims and others)
[Patent Document 5] JP3024101U (Claims and others)

However, in the light-weight clay disclosed in Patent Document 1, the proportion of water is too low, and the mixing ratio between the synthetic binder (carboxymethyl cellulose) and water is not optimum. Therefore, the clay has poor fluidity and gives insufficient shape retentivity.

In the light-weight clays disclosed in Patent Documents 2 and 3, the content of the binder resin (for example, a polyvinyl alcohol resin, a vinyl acetate resin containing a plasticizer, or polyethylene oxide) is too high, and the mixing ratio between the binder resin and water is not optimum. Therefore, the clays provide poor fluidity and insufficient shape retentivity.

More specifically, the light-weight clays disclosed in Patent Documents 1 to 3 cannot be readily squeezed out using a squeezer, and, when forcibly squeezed out, cannot retain the shape formed by a decorating tip. In the light-weight clays disclosed in Patent Documents 1 to 3, light-weight materials as additives can be readily broken during production. As a result of this, volatile components remaining in the light-weight materials scatter to the outside during long-term storage or at high ambient temperatures in summer months, and cause a problem of expansion of the whole light-weight clay to about 1.5 to 3 times the initial volume (herein after referred to as expansion problem).

In the light-weight clay disclosed in Patent Document 4, the addition quantity of the organic microballoon is low, and the mixing ratio between the binder resin and water is not optimum. Therefore, the light-weight clay provides insufficient shape retentivity, and still presents the expansion problem.

Regarding the clay 102 contained in the tube container, disclosed in Patent Document 5, there is no mention of the constitution of the clay, and no explanation or suggestion is made as to the influence of the mixing ratio between the binder resin and water on the fluidity or shape retentivity of the clay.

More specifically, in practical use of the clay 102 contained in the tube container, disclosed in the Patent Document 5, the clay cannot be readily squeezed out from the tube container through the decorating tip 104 having a predetermined shape. Even if the clay is forcibly squeezed out, the shape formed by the decorating tip 104 is hardly retained.

### SUMMARY OF THE INVENTION

The inventor of the present invention have found that the above-described expansion problem can be solved by a creamy light-weight molding material composed of a predetermined binder resin and a viscosity adjusting agent. In the creamy light-weight molding material, an addition quantity of the water, and a mixing ratio of water to a polyvinyl alcohol resin are adjusted to fall within predetermined ranges, whereby fluidity (squeezability) and shape retentivity, which are antithetical properties, are improved even if an addition quantity of a light-weight material is greatly changed.

More specifically, an object of the present invention is to provide a creamy light-weight molding material which has good fluidity to be readily squeezed through a decorating tip having a predetermined shape even when the addition quantity of the light-weight material is increased, provides excellent shape retentivity to retain the predetermined shape formed by the decorating tip, and provides excellent storage stability without the expansion problem.

The present invention provides a light-weight molding material composed of a binder resin containing a polyvinyl alcohol resin, a viscosity adjusting agent, water, and a light-weight material, wherein an addition quantity of the light-weight material is adjusted to a value within the range of from 3 to 22% by weight with reference to the total amount, and an addition quantity of the water is adjusted to a value within the range of from 65 to 92% by weight with reference to the total amount, and a mixing ratio (weight ratio) of water to the polyvinyl alcohol resin is adjusted to a value within the range of from 3 to 300. The light-weight molding material solves the above-described problems.

More specifically, even when the addition quantity of the light-weight material is greatly increased, the viscosity adjusting agent added to the certain binder resin improves the fluidity, whereby the creamy clay can be readily and quickly squeezed using a squeezer.

When the water content and the mixing ratio of water to the polyvinyl alcohol resin are adjusted within the predetermined ranges, the resultant light-weight molding material can be readily and quickly squeezed out using a squeezer, and provides excellent shape retentivity.

The creamy light-weight molding material significantly reduces the destruction of the light-weight material as an additive, and the initial packed state is maintained even stored for a long period of time or at high ambient temperatures in summer months or the like.

In prior art, the preferable ranges of the addition quantities of the light-weight material and water have been each independently established. When, for example, the mixing ratio of water to the polyvinyl alcohol resin is considered, the deterioration of the fluidity or shape retentivity is reduced, and the occurrence of the expansion problem is prevented even when the addition quantities of the light-weight material and water are increased.

In constituting the light-weight molding material of the present invention, the addition quantity of the polyvinyl alcohol-based resin as a binder resin is preferably adjusted to a value within the range of from 0.2 to 22% by weight with reference to the total amount.

With the above constitution, excellent fluidity and shape retentivity, etc. are provided even if the addition quantity of the light-weight material is increased or the addition quantity of water is greatly changed.

In constituting the light-weight molding material of the present invention, the addition quantity of the viscosity adjusting agent is preferably adjusted to a value within the range of from 0.1 to 20% by weight with reference to the total amount, and the mixing ratio (weight ratio) of water to the viscosity adjusting agent is preferably adjusted to a value within the range of from 3 to 920.

With the above constitution, excellent fluidity and shape retentivity, etc. are provided even if the addition quantity of the light-weight material is increased or the addition quantity of water is greatly changed.

In constituting the light-weight molding material of the present invention, the viscosity adjusting agent is preferably at least one compound selected from the group consisting of fatty acids, fatty acid salts, sulfonates, sulfate salts, and polysaccharides.

The use of the viscosity adjusting agent effectively prevents coagulation of the polyvinyl alcohol-based resin thereby providing excellent fluidity and shape retentivity, etc. over a long period of time.

In constituting the light-weight molding material of the present invention, when the viscosity adjusting agent such as a fatty acid is used as a first viscosity adjusting agent, a polyhydric alcohol is preferably contained as a second viscosity adjusting agent different from the first viscosity adjusting agent.

The combination of the first and second viscosity adjusting agents further improves the balance between the fluidity and shape retentivity, etc. and the molding material is more readily and quickly squeezed out using, for example, a squeezer.

In constituting the light-weight molding material of the present invention, the penetration into the light-weight molding material measured according to JIS K 2207 is preferably adjusted to a value within the range of from 8 to 80 mm (measuring temperature: 25° C.).

When the penetration is adjusted within the range, the light-weight molding material is readily and quickly squeezed out using, for example, a squeezer.

The creamy light-weight molding material having such a penetration significantly reduces the destruction of the light-weight material as an additive at the time of manufacture, and the initial packed state is maintained even stored for a long period of time or at high ambient temperatures in summer months or the like.

In constituting the light-weight molding material of the present invention, the ejection amount of the light-weight molding material squeezed out using a squeezer (volume: 250 ml, decorating tip: polygonal, outside diameter: 17 mm, inside diameter: 13 mm) is adjusted to a value within the range of from 2 to 250 cm³ in 10 seconds.

When the ejection amount is adjusted to a value within the predetermined range, the light-weight molding material provides not only excellent handling-ability, but also excellent shape retentivity and deformation resistance, etc. over a long period of time.

In constituting the light-weight molding material of the present invention, a volume shrinkage of the light-weight molding material is preferably adjusted to a value of 35% or less.

When the rate of volume change is adjusted to a value within the predetermined range, excellent shape retentivity is provided in initial stage and over the long term thereafter.

In constituting the light-weight molding material of the present invention, the light-weight material is preferably both of organic microballoon and inorganic microballoon or each.

The addition of these light-weight materials provides the light-weight molding material further excellent in the fluidity and lightness, and effectively reduces the expansion problem and deterioration of color developability.

In prior art, there has been a problem that the addition of inorganic microballoon to a polyvinyl alcohol resin instantly causes coagulation of the polyvinyl alcohol resin. This problem can be effectively prevented by adding a viscosity adjusting agent, and controlling the mixing ratio of water to the viscosity adjusting agent.

In constituting the light-weight molding material of the present invention, the light-weight molding material preferably further contains a coloring agent, and an addition quantity of the coloring agent is preferably adjusted to a value within the range of from 0.01 to 10% by weight with reference to the total amount.

Through the addition of the coloring agent, it is possible to obtain the light-weight molding material that is readily colored and provides excellent color developability.

In constituting the light-weight molding material of the present invention, the light-weight molding material is preferably in cream form, and retains the shape formed by the decorating tip when the light-weight molding material has been squeezed out from the decorating tip having a predetermined shape.

With the above constitution, for example, a pattern having a complicated shape is readily formed and maintained over a long period of time. Through the maintenance of the shape formed by the decorating tip, clays in different colors retain independence without being mixed with each other.

### BRIEF DESCRIPTION OF THE DRAWINGS

FIGS. 1A and 1B are graphs showing the relationships between the content of sodium lauryl sulfate and the deformation resistance, and between the content of sodium lauryl sulfate and the ejection amount, respectively;

FIGS. 2A and 2B are graphs showing the relationships between the mixing ratio of water to PVA and the ejection amount, and between the mixing ratio of water to PVA and the volume shrinkage, respectively;

FIGS. 3A and 3B are graphs showing the relationships between the content of microballoon (%) and the volume shrinkage (%), and between the content of microballoon (%) and the ejection amount, respectively;

FIGS. 4A and 4B are diagrams illustrating a method of measuring the penetration;

FIGS. 5A to 5D are diagrams illustrating how to use a light-weight molding material (for example, squeezing procedure, and decorating tip);

FIGS. 6A to 6B are diagrams illustrating a method of measuring the deformation resistance of the light-weight molding material;

FIG. 7 is a diagram illustrating an exemplary application of the light-weight molding material; and

FIG. 8 is a diagram illustrating a clay contained in a tube of prior art.

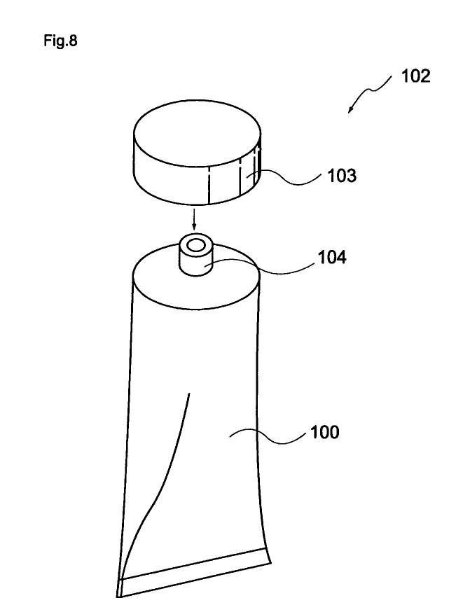

### DESCRIPTION OF THE PREFERRED EMBODIMENT

An embodiment of the present invention is a light-weight molding material including a binder resin containing a polyvinyl alcohol resin, a viscosity adjusting agent, water, and a light-weight material, wherein an addition quantity of the light-weight material is adjusted to a value within the range of from 3 to 22% by weight with reference to the total amount, an addition quantity of the water is adjusted to a value within the range of from 65 to 92% by weight with reference to the total amount, and a mixing ratio (weight ratio) of water to the polyvinyl alcohol resin is adjusted to a value within the range of from 3 to 300.

These components including the binder resin, viscosity adjusting agent, water, and light-weight material, etc. will be further described below.

### 1. Binder Resin

(1) Type

As for the type of the binder resin, a polyvinyl alcohol resin is used. The reason for this is that such a polyvinyl alcohol resin contains many hydroxy groups per unit weight, thereby providing, for example, adequate viscosity, fluidity, and aggregation properties, and imparts favorable properties to a light-weight clay in small amounts.

In addition, a polyvinyl alcohol resin has excellent water retentivity, and excellent compatibility with another water-soluble resin such as a hydroxy group-containing compound or a carboxyl group-containing compound.

Examples of the polyvinyl alcohol resin include polyvinyl alcohol obtained by saponification of vinyl acetate, modified polyvinyl alcohols having a carboxyl group in a side chain of its polyvinyl alcohol, modified polyvinyl alcohols having an amino group in a side chain of its polyvinyl alcohol, and modified polyvinyl alcohol having an alkyl group having 10 or more carbon atoms in a long-chain of its polyvinyl alcohol.

In order to obtain a uniformly creamy and smooth-textured light-weight molding material, it is effective to add a small amount of polyacrylic acid or a polyacrylic acid salt such as sodium polyacrylate.

If a vinyl acetate resin or polyethylene oxide, etc. is added to the binder resin, fluidity may significantly deteriorate, or the texture may deteriorates. Therefore, the content of such a resin or compound is preferably adjusted to a value of below 0.5% by weight with reference to the total amount.

(2) Addition Quantity

An addition quantity of the binder resin is preferably adjusted to a value within the range of from 0.2 to 30% by weight with reference to the total amount (100% by weight) of the light-weight molding material.

This is because if the addition quantity of the binder resin is below 0.2% by weight, the handling-ability or formability of the light-weight molding material may significantly deteriorate, while on the other hand, if the addition quantity of the binder resin is above 30% by weight, the spreadability of the light-weight molding material may deteriorate, or mixing and dispersion of the material may become difficult.

Accordingly, in order to further improve the balance between the spreadability of the light-weight molding material and the handling-ability or formability of the material, the addition quantity of the binder resin is preferably adjusted to a value within the range of from 0.3 to 25% by weight, and more preferably a value within the range of from 0.4 to 22% by weight with reference to the total amount.

The addition quantity of the polyvinyl alcohol resin as a part or whole of the binder resin is preferably adjusted to a value within the range of from 0.2 to 22% by weight with reference to the total amount (100% by weight) of the light-weight molding material.

This is because when the addition quantity is within the above-described range, fluidity and shape retentivity, etc. which are antithetical properties, are provided over a wide range of water content.

Accordingly, the addition quantity of the polyvinyl alcohol resin as the binder resin is more preferably adjusted to a value within the range of from 0.3 to 21% by weight, and even more preferably a value within the range of from 0.4 to 20% by weight with reference to the total amount of the light-weight molding material.

2. Viscosity adjusting agent

(1) Type

The viscosity adjusting agent is not particularly limited as to its type. A first viscosity adjusting agent is preferably at least one compound selected from the group consisting of fatty acids, fatty acid salts, sulfonates, sulfate salts, polysaccharides, nonion cellulose derivatives, acrylic amides, polyacrylic acids, polyacrylic acid salts, and Cyamoposis Gum.

Specific examples thereof include lauric acid, myristic acid, palmitic acid, stearic acid, oleic acid, sodium laurate, sodium myristate, sodium palmitate, sodium stearate, sodium oleate, sodium dodecylbenzene sulfonate, sodium octylbenzene sulfonate, sodium monoisopropylnaphthalene sulfonate, sodium diisobutylnaphthalene sulfonate, sodium triisopropylenenaphthalene sulfonate, sodium propyldiphenyl ether disulfonate, sodium lauryl sulfate, sodium sodium myristate sulfate, methyl cellulose, hydroxypropylmethyl cellulose, hydroxyethylmethyl cellulose, carboxylmethyl cellulose, hydroxypropyl cellulose, hydroxyethyl cellulose, propeneamide, Cyamoposis Gum, hydroxypropyl Cyamoposis Gum, and polyvinyl pyrrolidone. These compounds may be used alone or in combination of two or more of them.

The reason for this is that these compounds as viscosity adjusting agents are uniformly miscible with the polyvinyl alcohol resin, and facilitate the control of the viscosity (penetration) and fluidity of the light-weight molding material to fall within the predetermined ranges. In addition, these viscosity adjusting agents effectively prevent coagulation of the polyvinyl alcohol-based resin, thereby preventing the variation in the viscosity and moisture content of the whole light-weight molding material. Accordingly, for example, the viscosity, fluidity, and aggregation properties in early stages are maintained regardless of environmental variations.

Particularly preferable viscosity adjusting agents are lauric acid, sodium laurate, sodium lauryl sulfate, and sodium dodecylbenzene sulfonate, because they improve the thixotropy and shape retentivity of the polyvinyl alcohol resin, and effectively prevents coagulation of the resin in relatively small amounts.

It is preferable that the first viscosity adjusting agent such as a surfactant be combined with or replaced by a polyhydric alcohol as the second viscosity adjusting agent.

The reason for this is that a polyhydric alcohol is uniformly miscible with a polyvinyl alcohol resin to facilitate the control of the viscosity and fluidity (including ejection amount and penetration; herein after the same) of the light-weight molding material within the predetermined range, and provides excellent moisture retention effect.

Accordingly, it is preferable to add a polyhydric alcohol such as ethylene glycol, propylene glycol, or glycerol.

In order to more effectively prevent the coagulation of the polyvinyl alcohol resin, the polyhydric alcohol is preferably combined with the above-described lauric acid, sodium laurate, sodium lauryl sulfate, and sodium dodecylbenzene sulfonate.

(2) Addition Quantity

The addition quantity of the viscosity adjusting agent (the first or second viscosity adjusting agent) is preferably adjusted to a value within the range of from 0.1 to 20% by weight with reference to the total amount.

This is because if the addition quantity of the first or second viscosity adjusting agent is below 0.1% by weight, the deformation resistance and shape retentivity may deteriorate, or the coagulation of the polyvinyl alcohol resin cannot be sufficiently prevented, while on the other hand, if the addition quantity of the viscosity adjusting agent is above 20% by weight, the shape retentivity of the light-weight molding material may significantly deteriorate, and mixing and dispersion of the material may become difficult.

Accordingly, in order to further improve the balance between the shape retentivity of the light-weight molding material and the prevention of coagulation of the material, the addition quantity of the first or second viscosity adjusting agent is preferably adjusted to a value within the range of from 0.3 to 18% by weight, and more preferably a value within the range of from 0.5 to 16% by weight with reference to the total amount.

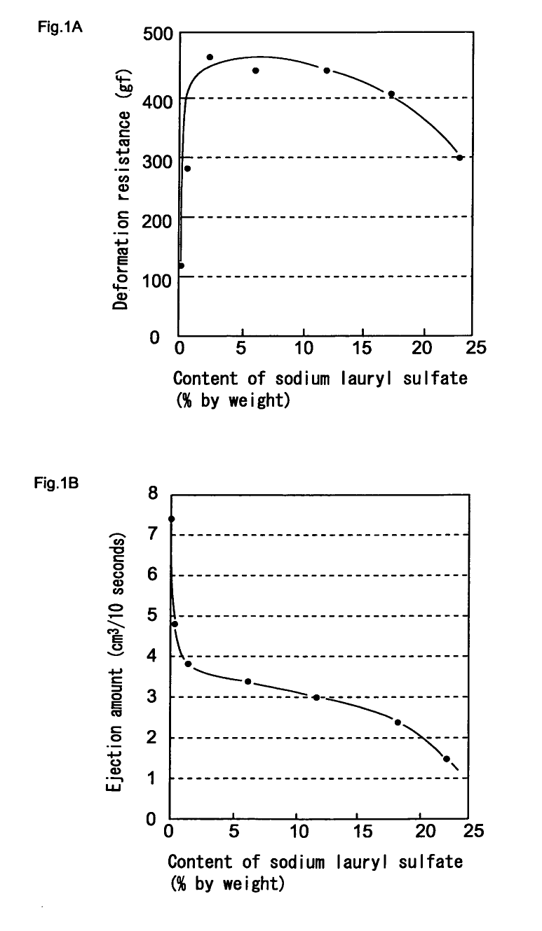

FIG. 1A is a graph plotting the content of the first viscosity adjusting agent (sodium lauryl sulfate) as abscissa, and the deformation resistance of Examples 12 to 15, and Comparison Examples 5 to 6, which will be described later, as ordinate. FIG. 1B is a graph plotting the content of the first viscosity adjusting agent (sodium lauryl sulfate) as abscissa, and the result (ejection amount 1) of the ejection test as ordinate.

The characteristic curve of the deformation resistance shown in FIG. 1A indicates that the addition of a small amount of the first viscosity adjusting agent sharply changes the deformation resistance value. The deformation resistance reaches a peak when the content of sodium lauryl sulfate is from 2 to 14%, and slowly decreases with keeping high levels as the content increases.

These facts suggest that the addition of the first viscosity adjusting agent develops favorable deformation resistance, and imparts viscoelasticity, formability, and shape retentivity which are required for the light-weight molding material.

The characteristic curve of the ejection amount shown in FIG. 1B indicates that the addition of the first viscosity adjusting agent remarkably reduces the ejection amount, but provides a favorable and stable ejection amount over a wide range of the content. More specifically, the ejection amount given in the ejection test sharply decreases when the content of sodium lauryl sulfate is about from 2 to 4%, but the predetermined ejection amount is maintained regardless the increase of the content.

These facts suggest that the addition of the first viscosity adjusting agent provides favorable ejection amounts, and imparts viscoelasticity, formability, and shape retentivity required for the light-weight molding material.

As understood from FIG. 1A and Tables 1 to 3, in order to provide favorable moldability and shape retentivity, the deformation resistance is preferably adjusted to a value within the range of from 130 to 1000 gf, and more preferably a value within the range of from 200 to 500 gf.

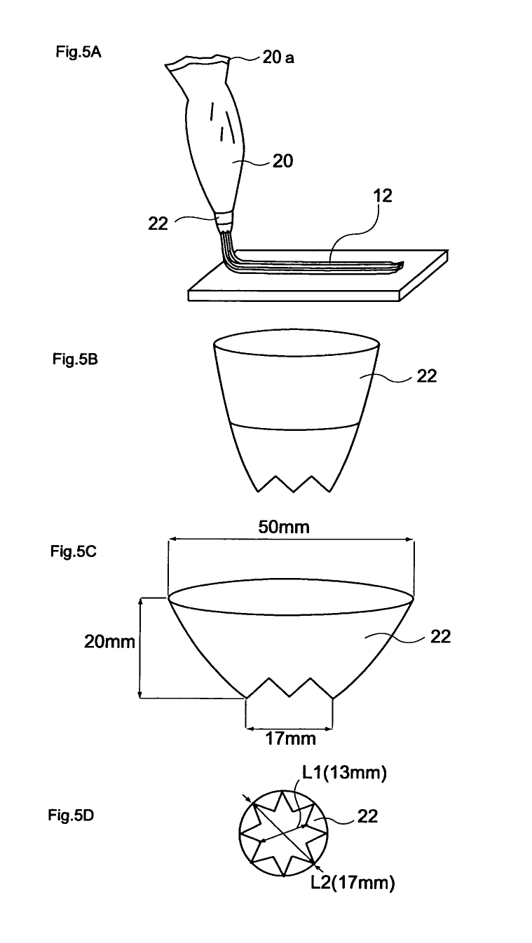

The preferable ranges of the ejection amount vary depending on the configuration of the decorating tip to be used. When a decorating tip as shown in FIG. 5B (polyethylene) is used, as understood from FIGS. 1B, 2A, and 3B, or Tables 1 to 3, the ejection amount is preferably adjusted to a value within the range of from 2 to 50 cm³/10 seconds, and more preferably a value within the range of from 3 to 25 cm³/10 seconds.

When a decorating tip as shown in FIG. 5C (chromium steel) is used, the ejection amount is preferably adjusted to a value within the range of from 2 to 150 cm³/10 seconds, and more preferably a value within the range of from 3 to 120 cm³/10 seconds.

(3) Mixing Ratio of Water to Viscosity Adjusting Agent

Regarding the addition quantity of the viscosity adjusting agent, more specifically the first viscosity adjusting agent, the mixing ratio of water to the viscosity adjusting agent is preferably adjusted to a value within the range of from 3 to 920.

This is because when the mixing ratio of water to the viscosity agent is adjusted within the range, excellent fluidity and shape retentivity, etc. are provided over a wide range of the water content, for example, from 65 to 92% by weight.

More specifically, when the mixing ratio of water to the viscosity adjusting agent is below 3, bubbles tend to form in the light-weight molding material, which can result in the deterioration of the shape. On the other hand, if the mixing ratio of water to the viscosity adjusting agent is above 920, sufficient deformation resistance cannot be developed, and the shape retentivity significantly deteriorates. In addition, coagulation of the polyvinyl alcohol resin may not be sufficiently prevented.

Accordingly, the mixing ratio of water to the viscosity adjusting agent is preferably adjusted to a value within the range of from 4 to 870, more preferably from 5 to 820, and most preferably from 10 to 80.

### 3. Water

(1) Addition Quantity of Water

The addition quantity of water such as water content is preferably determined in consideration of the handling-ability and formability of the light-weight molding material, or producibility of the light-weight molding material. For example, it is preferably adjusted to a value within the range of from 65 to 92% by weight with reference to the total amount.

This is because if the addition quantity of water is below 65% by weight, the control of the viscosity may become difficult, or fluidity may significantly deteriorate, which will result in the failure to provide a squeezable clay, while on the other hand, if the addition quantity of water is above 92% by weight, the control of creep resistance may become difficult, and the shape retentivity may significantly deteriorate.

Accordingly, the addition quantity of water is more preferably adjusted to a value within the range of from 66 to 91% by weight with reference to the total amount.

The preferable ranges of the addition quantity of water defined in Patent Documents 1 to 4 are from 50 to 60%, from 15 to 55%, from 50 to 80%, and from 65 to 85% by weight, respectively. However, in these documents, no consideration is given to the mixing ratio of water to the polyvinyl alcohol resin is not optimized, and the mixing ratio of water to the viscosity adjusting agent. In prior art, the increase of the mixing ratio of water has caused softening of the material which results in poor moldability and impairment of lightness. These problems are solved by the optimization of the mixing ratio of water to the polyvinyl alcohol resin and others.

(2) Mixing Ratio of Water to Polyvinyl Alcohol Resin

Regarding the water content, the mixing ratio (weight ratio) of water to the polyvinyl alcohol resin is characteristically adjusted to a value within the range of from 3 to 300.

This is because when the mixing ratio is adjusted within the range, excellent fluidity and shape retentivity are provided, and the expansion problem is effectively prevented over a wide range of water content.

If the mixing ratio of water to the polyvinyl alcohol resin is below 3, the deformation resistance and volume shrinkage of the light-weight molding material may increase, the fluidity and shape retentivity may deteriorate, and the coagulation of the polyvinyl alcohol resin cannot be prevented to make it difficult to suppress the expansion problem.

On the other hand, if the mixing ratio of water to the polyvinyl alcohol resin is above 300, the shape retentivity may significantly deteriorate, the volume shrinkage may increase, and prevention of the coagulation of the polyvinyl alcohol resin may become difficult.

Accordingly, the mixing ratio (weight ratio) of water to the polyvinyl alcohol resin is preferably adjusted to a value within the range of from 3 to 270, more preferably from 3 to 250, and most preferably from 4 to 50.

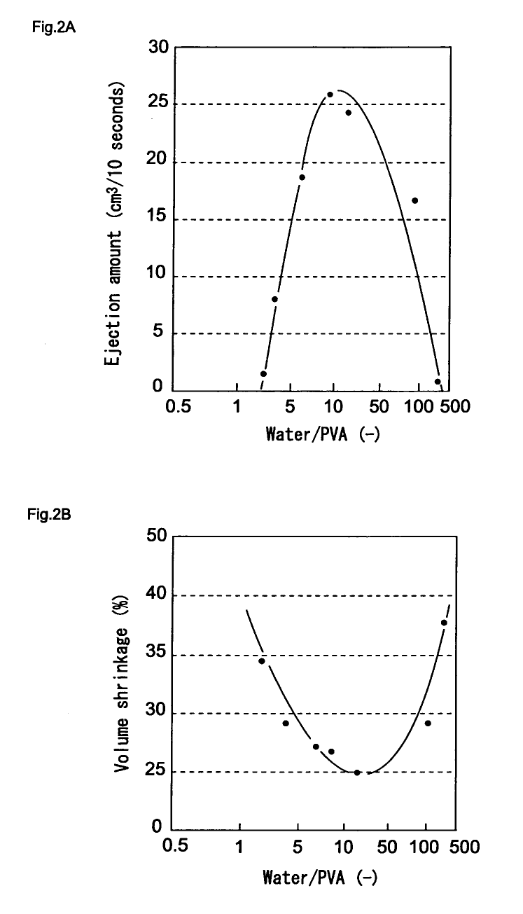

With reference to FIGS. 2A to 2B, the mixing ratio of water to the polyvinyl alcohol resin and the relationship between the fluidity and shape retentivity of the light-weight molding material are further described. In FIG. 2A, the mixing ratio of water to the polyvinyl alcohol resin is plotted along abscissa, and the ejection amount given in the ejection test is plotted along ordinate. In FIG. 2B, the volume shrinkage is plotted along ordinate. The characteristic curves shown in FIGS. 2A and 2B present data of the ejection test on and volume shrinkage of Examples and Comparison Examples.

As understood from the characteristic curves shown in FIGS. 2A and 2B, when the ratio of water to the polyvinyl alcohol resin is a value within the range of from 3 to 300, excellent balance is achieved between the ejection amount and the volume shrinkage even if the addition quantity of water in the light-weight molding material is high (in this case, from 65 to 92% by weight).

It will be understood that further improved balance is achieved between the fluidity and shape retentivity when the ratio of water to the polyvinyl alcohol resin is a value within the range of from 4 to 250.

### 4. Light-Weight Material

(1) Type

The light-weight material is not particularly limited as to its type or kind, but preferable examples thereof include organic microballoon and inorganic microballoon.

The organic microballoon is preferably composed of an organic outer shell (outer skin) having a void inside. More specifically, the outer shell is preferably composed of, for example, a vinylidene chloride-acrylonitrile copolymer resin, a vinyl acetate-acrylonitrile copolymer resin, a methyl methacrylate-acrylonitrile copolymer resin, or an acrylonitrile resin, and contains a gas or liquid.

In order to provide high whiteness, the organic microballoon preferably has an outer shell composed of a vinyl acetate-acrylonitrile copolymer resin, a methyl methacrylate-acrylonitrile copolymer resin, an acrylonitrile resin, and the like.

The light-weight material may be organic microballoon, or inorganic microballoon having an outer shell composed of an inorganic material such as glass.

The inorganic microballoon is color less and transparent, and provide high compression strength to give a residual rate of from 90 to 92 (vol %), when compressed at a pressure of, for example, 750 psi (1 psi=6.90×10³ N, 1 kgf=9.807 N/cm²).

Accordingly, the combination of the organic and inorganic microballoon remarkably reduces the weight of the light-weight molding material per unit volume, and the organic microballoon surrounding the inorganic microballoon serves as cushion materials to effectively prevent the destruction of the inorganic microballoon, and further improve the dispersibility of the inorganic microballoon.

In addition, the combination of the organic and inorganic microballoon improves the shape retentivity and reduces the shrinkage of the light-weight molding material, and improves its color developability in cooperation with a coloring agent.

(2) Average Particle Size

An average particle size of the light-weight material is adjusted to a value within the range of from 10 to 150 μm.

This is because if the average particle size of the light-weight material is below 10 μm, moldability of the light-weight molding material may deteriorate, or weight reduction of the material may become difficult even if a predetermined amount of the light-weight material is added, while on the other hand, if the average particle size of the light-weight material is above 150 μm, mixing and dispersion of the material may become difficult, or moldability of the light-weight molding material may deteriorate.

Accordingly, the average particle size of the light-weight material is more preferably adjusted to a value within the range of from 15 to 130 μm, and even more preferably a value within the range of from 20 to 110 μm.

The average particle size of the light-weight material may be determined by analyzing an optical microscope image of the light-weight material by use of an image processing apparatus.

(3) Addition Quantity

An addition quantity of the light-weight material such as light-weight material content is characteristically adjusted to a value within the range of from 3 to 22% by weight with reference to the total amount.

This is because if the addition quantity of the light-weight material is below 3% by weight, weight reduction of the light-weight molding material may become difficult, or the shape retentivity of the material may significantly deteriorate, while on the other hand, if the addition quantity of the light-weight material is above 22% by weight, the moldability and handling-ability of the light-weight molding material may significantly deteriorate, and mixing and dispersion of the material may become difficult.

Accordingly, in order to further improve the balance between the weight reduction and handling-ability and other properties of the light-weight molding material, the addition quantity of the light-weight material is more preferably adjusted to a value within the range of from 4.5 to 21% by weight, and even more preferably from 6 to 20% by weight with reference to the total amount.

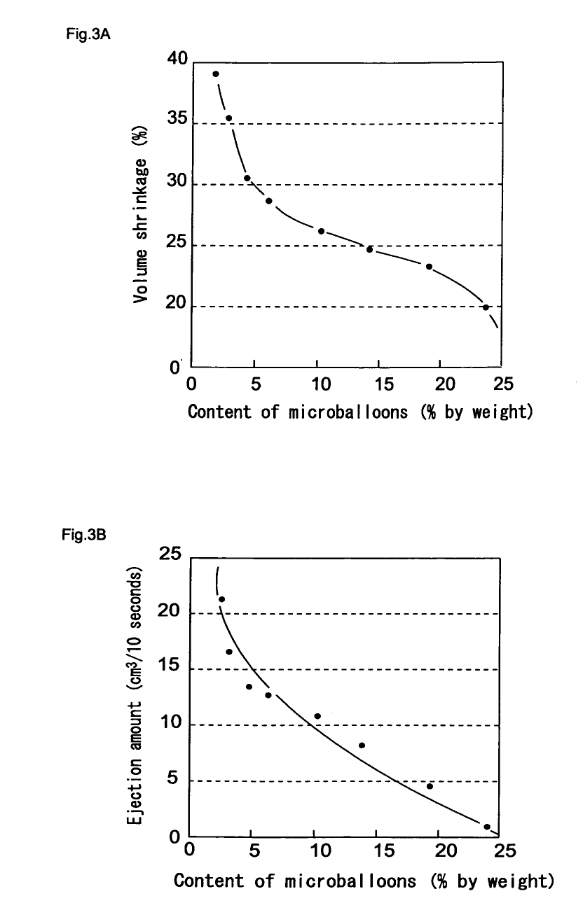

FIG. 3A shows the relationship between the content of microballoon and the volume shrinkage, and FIG. 3B shows the relationship between the content of microballoon and the result of the ejection test.

The characteristic curve shown in FIG. 3A indicates that the volume shrinkage increases as the content of the microballoon increases. More specifically, the rate of decrease of the volume shrinkage temporarily slows down when the content of the microballoon is about 4.5% by weight, and the volume shrinkage starts to decrease again when the content of the microballoon exceeds 4.5% by weight.

The characteristic curve shown in FIG. 3B indicate that the ejection amount decreases as the content of the microballoon increases. More specifically, the ejection amount sharply decreases until the content of the microballoon reaches about 6.0% by weight, and slowly decreases after the content of the microballoon exceeds 6.0% by weight.

Accordingly, in consideration of the characteristic curves shown in FIGS. 3A to 3B, adjustment of the content of the microballoon to a value within the range of from 6 to 20% by weight provides a light-weight molding material having further well-balanced properties.

### 5. Additives

(1) Fibers

Fibers (pulp) as an additive may significantly deteriorate the fluidity of the light-weight molding material. Accordingly, the addition quantity of fibers (pulp) is preferably 6% by weight or less with reference to the total amount.

(2) Coloring Agent

For coloring purposes, it is preferable to add a coloring agent. The coloring agent is not particularly limited as to its type, and may be known one used in the fields of, for example, inks and paints. Examples of the coloring agent include organic pigments, inorganic pigments, and dyes.

The addition quantity of the coloring agent is preferably adjusted to a value within the range of from 0.01 to 10% by weight with reference to the total amount.

This is because if the addition quantity of the coloring agent is below 0.01% by weight, the addition effect and the synergy with the light-weight material may be not exhibited, which results in deterioration of the color developability by the coloring agent, while on the other hand, if the addition quantity of the coloring agent is above 10% by weight, the coloring agent may increase light scattering, or tends to cause aggregation, which can result in the deterioration of the color developability.

Accordingly, in order to further improve the color developability by the coloring agent, the addition quantity of the coloring agent is more preferably adjusted to a value within the range of from 0.02 to 8% by weight, and even more preferably from 0.03 to 7% by weight.

(3) Other Additives

The light-weight molding material preferably contains, in addition to the above-described additives, one or more other additives such as a fungicide, an antibacterial agent, an antioxidant, an ultra violet absorbing agent, an oil, a wax, a thickener, a plasticizer, a surfactant other than a viscosity adjusting agent, and an organic solvent.

### 6. Penetration Property

The penetration property into the light-weight molding material measured according to JIS K 2207 is preferably adjusted to a value within the range of from 8 to 80 mm (measuring temperature: 25° C.).

This is because when the penetration into the light-weight molding material, which is an index of the viscosity, is within the range, the material is readily and quickly squeezed out using, for example, a squeezer, and in addition, a creamy light-weight molding material giving such a penetration remarkably reduces the destruction of the light-weight material as an additive. Accordingly, the initial packaging condition is maintained even stored for a long period of time or at high ambient temperatures in summer months or the like without causing the expansion problem.

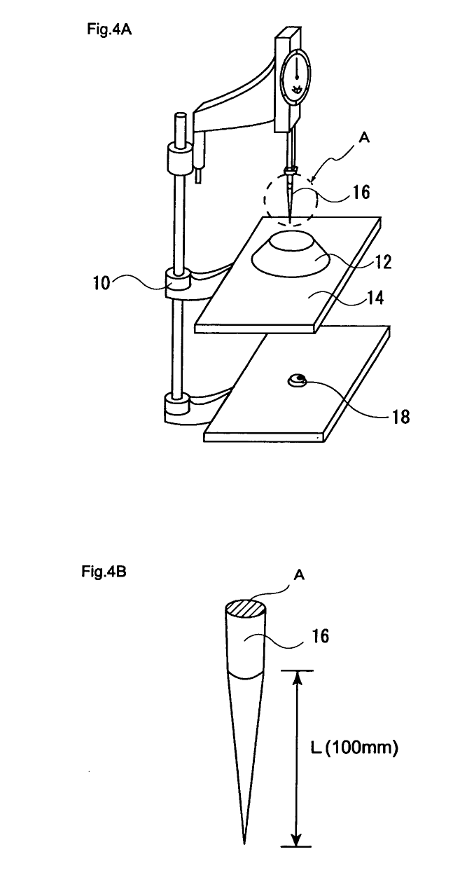

The penetration into the light-weight molding material may be measured using an apparatus 10 as shown in FIG. 4A according to JIS K 2207; a light-weight molding material 12 having a flat top surface is mounted on the stage, and a probe 16 shown in FIG. 4B is inserted into the light-weight molding material 12 from its top surface.

More specifically, the probe 16 having a maximum sectional area (A) of 0.5 cm² on the top surface, and a needle length (L) of 100 mm is subjected to a load of 50 g, and the penetration depth after 30 seconds is determined as the penetration in terms of the millimeter.

The viscosity and penetration may be significantly varied by excessive change of the surrounding temperature in winter or summer months, which may result in the deterioration of the fluidity or the infrequent occurrence of the expansion problem.

Accordingly, in order to achieve excellent squeezability and prevent the expansion problem during all seasons, the penetration into the light-weight molding material is more preferably adjusted to a value within the range of from 15 to 73 mm, and even more preferably a value within the range of from 22 to 67 mm.

### 7. Volume Shrinkage

The volume shrinkage of the light-weight molding material is preferably adjusted to a value of 35% or less.

This is because if the volume shrinkage is above 35%, the material may be significantly deformed during drying, which makes it difficult to maintain the initial shape over a long period of time.

However, if the volume shrinkage is excessively small, the addition quantity of the usable light-weight material may be excessively increased, or the type of the binder resin or viscosity adjusting agent may be excessively limited.

Accordingly, the volume shrinkage of the light-weight molding material is more preferably adjusted to a value within the range of from 1% to 34%, and even more preferably a value within the range of from 2% to 33%.

The volume shrinkage is variable also by the addition quantity of the light-weight material, binder resin, viscosity adjusting agent, and others to be used.

For example, as shown in FIGS. 2B and 3A, the volume shrinkage can be widely changed by changing the mixing ratio of water to the polyvinyl alcohol, or the content of the microbaloons.

More specifically, when the content of the microbaloons is from 6 to 21% by weight, a volume shrinkage of about 35% or less is further stably achieved.

Furthermore, when the mixing ratio of water to the polyvinyl alcohol is from 3 to 300, a volume shrinkage of about 35% or less is achieved.

Accordingly, a light-weight molding material which has excellent lightness and fluidity, and maintains a desired shape over a long period of time is provided by appropriately changing the mixing ratio of water to the polyvinyl alcohol and the content of the microbaloons.

### 8. Production Method

(1) Mixing Step

During the mixing step, constituent materials such as a binder resin, a light-weight material, a viscosity adjusting agent, a coloring agent, and water are uniformly mixed. In order to uniformly mix these constituent materials, it is preferable to use, for example, a propeller mixer, a kneader, a planetary mixer, a three roller blender, or a ball mill.

In particular, the light-weight material is so light that readily broken during kneading, and tends to be unevenly dispersed. Therefore, the constituent materials are preferably mixed by extrusion kneading for 1 to 60 minutes using a kneader at a rotational speed of 10 to 1,000 rpm, and more preferably extrusion kneading for 10 to 30 minutes using a kneader at a rotational speed of 30 to 300 rpm.

The light-weight molding material of the present invention remarkably reduces the destruction of the light-weight material and others, so that the expansion problem can be effectively prevented even if the kneading conditions are somewhat varied by, for example, the change in the surrounding temperature.

In order to uniformly mix and disperse the coloring agent, it is preferable that the coloring agent should be dispersed in water or an alcohol to make a solution, and an alkaline chemical or the like be added to the solution to adjust the pH to 7, thereby preventing aggregation of the solution.

During mixing of the constituent materials, for example, the temperature is preferably kept at 30 to 70° C.

This is because if the temperature during mixing is lower than 30° C., the constituent materials may not be uniformly mixed, while on the other hand, if the temperature during mixing is higher than 70° C., the resultant light-weight molding material may be inextensible and brittle.

Accordingly, the temperature during mixing of the constituent materials is more preferably from 35 to 60° C., and even more preferably from 40 to 55° C.

(2) Penetration Adjusting Step

In the penetration adjusting step, the penetration into the light-weight molding material is adjusted. The penetration into the light-weight molding material, which is measured according to JIS K 2207, is preferably adjusted to a value, for example, from 8 to 80 (25° C.) through the addition of water and a viscosity adjusting agent.

This is because if the penetration into the light-weight molding material is below 8, the resultant light-weight molding material may be inextensible and brittle, and deteriorates in handling-ability, while on the other hand, if the penetration into the light-weight molding material is above 80, the surface becomes sticky and the handling-ability may deteriorate.

The light-weight molding material of the present invention contains a viscosity adjusting agent, and a relatively large amount of water, so that the penetration into the light-weight molding material can be readily adjusted to fall within the predetermined range.

When measured at a temperature of 40° C., the penetration into the light-weight molding material is preferably adjusted to a value within the range of from 8 to 70, and more preferably a value within the range of from 20 to 58.

The reason for this is that the penetration into the light-weight molding material is remarkably reduced just by heating the light-weight molding material to about 40° C. This further facilitates squeezing of the material using a squeezer. The light-weight molding material heated to about 40° C. immediately cools down to room temperature after being squeezed out using a squeezer, which remarkably improves the shape retentivity of the light-weight molding material.

Accordingly, it is preferable to provide a heating device near the decorating tip of the squeezer used for the light-weight molding material.

(3) Packaging Step

It is preferable to provide a packaging step wherein the light-weight molding material is divided into small packages. The light-weight molding material usually contains relatively large amounts of water and an alcohol. In order to achieve predetermined handling-ability while keeping the moisture content in the light-weight molding material, the material is preferably packed by a moisture-resistant material, for example, a plastic material such as polyethylene or polypropylene.

In particular, polyethylene used as the packaging material does not stick to the light-weight molding material, and a creamy light-weight molding material can be readily squeezed out from the package. Polypropylene is also a preferable packaging material, because it allows heat sealing while keeping the predetermined moisture resistance. Amore preferable packaging material is a composite film composed of an inner layer of polyethylene and an outer layer of polypropylene. The composite film provides non-stickiness of polyethylene and moisture resistance of polypropylene.

The light-weight molding material of the present invention is usually squeezed out under pressure. In order to prevent backflow of the material, as shown in FIG. 5A, it is preferable to provide a heat seal area 20a around the package of the light-weight molding material after the light-weight molding material is packed.

In order to readily squeeze out the light-weight molding material under pressure, the decorating tip is preferably composed of polyethylene or polypropylene, and the circumference of the tip is preferably heat-sealed, or mechanically screwed onto the package with a packing between them.

In order to further readily squeeze out the light-weight molding material, it is preferable that the base material of the decorating tip should be composed of a metal or plastic material, and the surface thereof be coated with chromium. The reason for this is that coating of the decorating tip with a chromium layer at a predetermined thickness produces a surface having remarkably higher smoothness and lower dynamical friction than other metals.

More specifically, it is known that coating of the metal base material such as iron with chromium at a thickness of 0.1 to 5 μm increases the ejection amount by 5 to 10 times that obtained by a decorating tip without chromium coating. For example, in Example 1, it has been found that the light-weight molding material is squeezed out through the decorating tip coated with chromium at a thickness of 0.5 μm as shown in FIG. 5C at a rate of about 150 cm³/10 seconds, and the rate is higher obtained by the decorating tip composed of polyethylene as shown in FIG. 5B.

The light-weight molding material of the present invention sufficiently prevents the occurrence of the expansion problem, so that the packaging material for the light-weight molding material does not require air holes or high gas permeability, different from packaging materials of prior art.

### EXAMPLES

The present invention will be further described in detail with reference to the following examples and Comparison Examples.

### Example 1

### (1) Preparation of Light-Weight Molding Material

The following constituent materials A to F were placed in a 200 litter-kneader, and the kneader was rotated at a rotational speed of 40 rpm to prepare a light-weight molding material (density: 0.40 g/cm³).

The PVA used herein was a partially saponified PVA, a 4% aqueous solution of which exhibited a viscosity of 4000 mPa·s at 20° C.

| | |
|---|---|
| A: Organic microballoon | 0.372 kg |
| (average particle size: 35 μm, L value (whiteness): 50 or | |
| more, neutral product) | |
| B: Polyvinyl alcohol resin | 0.684 kg |
| (high viscosity PVA; 4% aqueous solution has a viscosity of | |
| 4000 mPa · s at 20° C) | |
| C: Oleic acid | 0.132 kg |
| D: Propylene glycol | 0.012 kg |
| E: Water | 10.8 kg |

### (2) Evaluation of Light-Weight Molding Material

The resultant light-weight molding material was subjected to the following evaluations of the penetration, fluidity, shape retentivity, lightness, and expansion properties. The obtained results are summarized in Table 1 (average of five samples)

(2)-1 Measurement of Penetration Property

As an index of the viscosity of the resultant light-weight molding material, the penetration into the material was measured at 25° C. and 40° C. using a penetration measuring device 10 shown in FIG. 4A (JIS K 2207-compliant).

The penetration was determined by subjecting a needle having a length (L) of 100 mm to a load of 50 g, and measuring the penetration depth after 30 seconds in terms of the millimeter.

(2)-2 Squeezability

As another index of the viscosity of the resultant light-weight molding material, the squeezability of the material was evaluated according to the following criteria. More specifically, as shown in FIG. 5A, the ejection amount (volume (cm³/10 seconds)) of the light-weight molding material squeezed out using a squeezer 20 (volume: 250 ml, decorating tip: polygonal, outside diameter: 17 mm, inside diameter: 13 mm) during a unit time of 10 seconds was measured.

The decorating tip was equipped with a polyethylene decorating tip as shown in FIG. 5B or a chromium-coated (1 μm) steel decorating tip as shown in FIG. 5C, and the ejection amounts were evaluated as ejection amounts 1 and 2, respectively.

Each of the polyethylene decorating tip as shown in FIG. 5B and the chromium-coated (1 μm) steel decorating tip as shown in FIG. 5C has a bottom as shown in FIG. 5D, wherein L1 represents the inside diameter, and L2 represents the outside diameter.

(2)-3 Volume Shrinkage

The volume shrinkage of the resultant light-weight molding material was evaluated according to the following criteria. A vessel having a known volume (V1) was filled with a certain amount of the light-weight molding material, and the weight of the material (W1) was measured. Thereafter, the same weight (W1) of the light-weight molding material was molded into a plate, and dried at 32° C. for 120 hours.

After waterproofing the surface of the dried light-weight molding material, the light-weight molding material was immersed in a vessel having a known volume and filled with water, and the volume (V2) of the dried light-weight molding material was calculated from the amount of overflow water.

Using the obtained V1 and V2, the shrinkage (%) of the light-weight molding material by drying is calculated by the following formula.

Volume shrinkage (%)=(V1−V2)/V1×100

(2)-4 Shape

The shape of the light-weight molding material was evaluated as follows. 30 g of the light-weight molding material was squeezed out using a squeezer 20 as shown in FIG. 5A (volume: 250 ml, decorating tip: polygonal, outside diameter: 17 mm, inside diameter: 13 mm) equipped with a decorating tip made of polyethylene as shown in FIG. 5B, and the sectional shape was evaluated based on whether it was polygonal or not.

When the shape is rated as Good or higher, the light-weight molding material is regarded to have satisfactory shape retentivity.

Very good: Complete polygonal shape is reproduced.
Good: Almost complete polygonal shape is reproduced.
Fair: Slightly distorted but almost polygonal shape is reproduced.
Bad: Polygonal shape is not reproduced.

(2)-5 Deformation Resistance

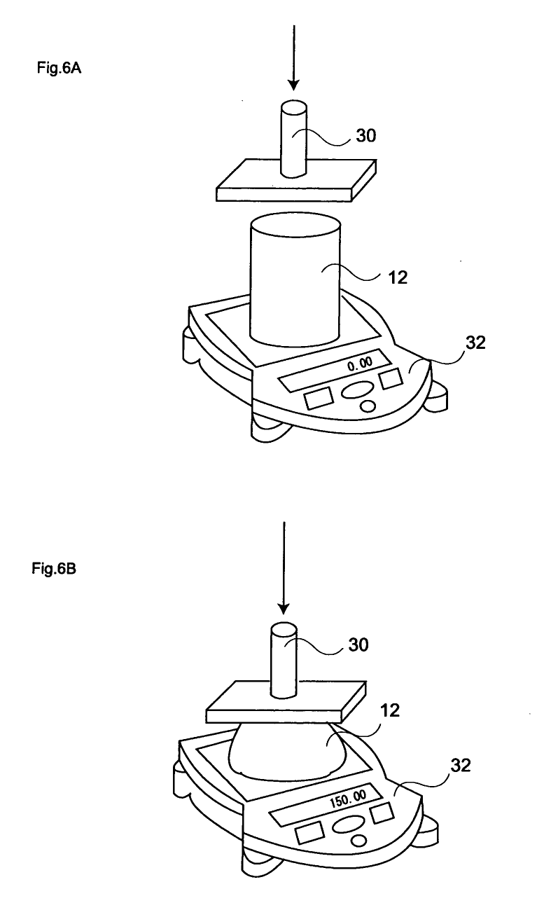

As shown in FIG. 6A, the light-weight molding material 12 was molded into a cylinder having a diameter of 38 mm and a height of 95 mm, and placed on a scale 32. Subsequently, as shown in FIG. 6B, a hydraulic piston 30 was lowered at a rate of 18.6 cm/minute to press down the light-weight molding material 12. When the height of the light-weight molding material was decreased from 95 mm to 70 mm, the value of the scale was read, and the reading was used as the deformation resistance of the light-weight molding material.

The deformation resistance is an index of the formability and shape retentivity of the light-weight material. It has been indicated that good fluidity and shape retentivity are obtained when the deformation resistance is adjusted to a value within the range of from 150 to 1000 gf.

### Examples 2 to 6, Comparison Examples 1 to 2

In Examples 2 to 6 and Comparison Examples 1 to 2, the mixing ratio of water to the light-weight material was changed as shown in Table 1, and the physical properties of the resultant light-weight materials were investigated. More specifically, the amount and average particle size of the light-weight material (organic microballoon) and the mixing ratio of water were changed as shown in Table 1, and oleic acid was used as the first viscosity adjusting agent and propylene glycol was used as the second viscosity adjusting agent. The physical properties of the resultant light-weight molding materials were compared with each other.

The PVA used herein was a partially saponified PVA, a 4% aqueous solution of which has a viscosity of 4000 mPa·s at 20° C.

The light-weight molding materials were evaluated in the same manner as in Example 1, and the obtained results are summarized in Table 1.

As readily understood from the result, when the addition quantity of the organic microballoon is below 3% by weight, the evaluation of the shape, shape retentivity, volume shrinkage, and lightness significantly deteriorates. On the other hand, when the addition quantity of the organic microballoon is above 22% by weight, dispersibility of the organic microballoon deteriorates, and the evaluation of the shape and ejection amount deteriorates.

TABLE 1

| | | | | | | | Comparative | Comparative |
|---|---|---|---|---|---|---|---|---|
| | Example 1 | Example 2 | Example 3 | Example 4 | Example 5 | Example 6 | Example 1 | Example 2 |
| Light-weight | 3.1 | 4.5 | 6.0 | 10.0 | 14.0 | 19.0 | 2.5 | 24.0 |
| material | | | | | | | | |
| (% by weight) | | | | | | | | |
| Average particle | 35 | 35 | 35 | 35 | 22 | 22 | 35 | 22 |
| size of light- | | | | | | | | |
| weight material | | | | | | | | |
| (μm) | | | | | | | | |
| Water | 90.0 | 88.6 | 87.1 | 83.1 | 79.1 | 74.1 | 90.6 | 69.1 |
| (% by weight) | | | | | | | | |
| PVA | 5.7 | 5.7 | 5.7 | 5.7 | 5.7 | 5.7 | 5.7 | 5.7 |
| (% by weight) | | | | | | | | |
| First viscosity | 1.1 | 1.1 | 1.1 | 1.1 | 1.1 | 1.1 | 1.1 | 1.1 |
| adjusting agent | | | | | | | | |
| (% by weight) | | | | | | | | |
| Second viscosity | 0.1 | 0.1 | 0.1 | 0.1 | 0.1 | 0.1 | 0.1 | 0.1 |
| adjusting agent | | | | | | | | |
| (% by weight) | | | | | | | | |
| Water/PVA | 15.8 | 15.5 | 15.3 | 14.6 | 13.9 | 13.0 | 15.9 | 12.1 |
| Water/ | 81.8 | 80.5 | 79.2 | 75.5 | 71.9 | 67.4 | 82.4 | 62.8 |
| first viscosity | | | | | | | | |
| adjusting agent | | | | | | | | |
| Ejection amount 1 | 15.9 | 13.1 | 12.4 | 10.2 | 7.4 | 4.0 | 22.0 | 0.2 |
| (cm³/10 seconds) | | | | | | | | |
| Ejection amount 2 | 121 | 82 | 69 | 58 | 50 | 18 | 185 | 1 |
| (cm³/10 seconds) | | | | | | | | |
| Shape | Fair | Good | Very | Very | Very | Good | Bad | Fair |
| | | | good | good | good | | | |
| Volume shrinkage | 34 | 30 | 28 | 27 | 25 | 24 | 39 | 21 |
| (%) | | | | | | | | |
| Deformation | 150 | 230 | 320 | 630 | 850 | 970 | 90 | 1400 |
| resistance | | | | | | | | |
| (gf) | | | | | | | | |
| Penetration test | 80 | 55 | 34 | 20 | 16 | 9 | — | 7 |
| (25° C./mm) | | | | | | | | |
| Penetration test | — | 66 | 39 | 24 | 19 | 11 | — | 8 |
| (40° C./mm) | | | | | | | | |
| Density (g/cm³) | 0.40 | 0.34 | 0.27 | 0.16 | 0.30 | 0.23 | 0.44 | 0.18 |

### Examples 7 to 11, Comparison Examples 3 and 4

In Examples 7 to 11 and Comparison Examples 3 and 4, the mixing ratio of water to PVA was changed as shown in Table 2, and the physical properties of the resultant light-weight molding materials were examined. More specifically, the content of the light-weight molding material was 7.3% by weight, and the average particle size of the light-weight material was 35 μm.

When the content of PVA was low, a high viscosity PVA, a 4% aqueous solution of which has a viscosity of 4000 mPa·s at 20° C., was used, and when the content of PVA was high, a moderate viscosity PVA, a 4% aqueous solution of which has a viscosity of 60 mPa·s at 20° C., was used. The contents of water and PVA in the light-weight molding materials were changed in the same manner as in Example 1. Sodium stearate was used as the first viscosity adjusting agent, and propylene glycol was used as the second viscosity adjusting agent.

The light-weight molding materials were evaluated in the same manner as in Example 1, and the obtained results are summarized in Table 2.

As readily understood from the results, when the mixing ratio of water to PVA is below 3, the ejection amount and shape retentivity significantly deteriorates, and the volume shrinkage increases. On the other hand, when the mixing ratio of water to PVA is above 300, handling-ability significantly deteriorates, the ejection amount and shape significantly deteriorate, and the volume shrinkage increases.

TABLE 2

| | | | | Example | Example | Comparative | Comparative |
|---|---|---|---|---|---|---|---|
| | Example 7 | Example 8 | Example 9 | 10 | 11 | Example 3 | Example 4 |
| Light-weight | 7.3 | 7.3 | 7.3 | 7.3 | 7.3 | 7.3 | 7.3 |
| material | | | | | | | |
| (% by weight) | | | | | | | |
| Average particle | 35 | 35 | 35 | 35 | 35 | 35 | 35 |
| size of light- | | | | | | | |
| weight material | | | | | | | |
| (μm) | | | | | | | |
| Water | 73.1 | 79.1 | 82.6 | 86.1 | 90.2 | 68.0 | 90.8 |
| (% by weight) | | | | | | | |
| PVA | 18.0 | 12.0 | 8.5 | 5.0 | 0.9 | 23.1 | 0.3 |
| (% by weight) | Moderate | Moderate | High | High | High | Moderate | High |
| | viscosity | viscosity | viscosity | viscosity | viscosity | viscosity | viscosity |
| First viscosity | 1.5 | 1.5 | 1.5 | 1.5 | 1.5 | 1.5 | 1.5 |
| adjusting agent | | | | | | | |
| (% by weight) | | | | | | | |
| Second viscosity | 0.1 | 0.1 | 0.1 | 0.1 | 0.1 | 0.1 | 0.1 |
| adjusting agent | | | | | | | |
| (% by weight) | | | | | | | |
| Water/PVA | 4.1 | 6.6 | 9.7 | 17.2 | 100.2 | 2.9 | 302.7 |
| Water/ | 48.7 | 52.7 | 55.1 | 57.4 | 60.1 | 45.4 | 60.5 |
| first viscosity | | | | | | | |
| adjusting agent | | | | | | | |
| Ejection amount 1 | 8.3 | 18.8 | 25.9 | 24.8 | 17.0 | 1.5 | 0.9 |
| (cm³/10 seconds) | | | | | | | |
| Shape | Fair | Good | Very | Very | Very | Bad | Bad |
| | | | good | good | good | | |
| Volume shrinkage | 29 | 27 | 26 | 25 | 29 | 36 | 37 |
| (%) | | | | | | | |
| Deformation | 530 | 270 | 200 | 230 | 350 | 1010 | — |
| resistance | | | | | | | |
| (gf) | | | | | | | |
| Penetration test | 8 | 12 | 14 | 19 | 20 | 6 | 20 |
| (25° C./mm) | | | | | | | |
| Penetration test | 10 | 14 | 16 | 22 | 24 | 7 | 22 |
| (40° C./mm) | | | | | | | |
| Density (g/cm³) | 0.20 | 0.20 | 0.19 | 0.19 | 0.18 | 0.21 | 0.17 |

### Examples 12 to 16, Comparison Examples 5 to 6

In Examples 12 to 16 and Comparison Examples 5 to 6, the mixing ratio of the first viscosity adjusting agent was changed as shown in Table 3, and the physical properties of the resultant light-weight molding materials were examined. More specifically, the content of the light-weight molding material was 6.2% by weight, and the average particle size of the light-weight material was 35 μm. The evaluation was made on light-weight moldings containing different amounts of water and the first viscosity adjusting agent prepared in the same manner as in Example 1. Sodium lauryl sulfate was used as the first viscosity adjusting agent and glycerol was used as the second viscosity adjusting agent, and the physical properties of the resultant light-weight materials were compared with each other.

The PVA used herein was a 4% high viscosity modified PVA, an aqueous solution of which has a viscosity of 4000 mPa·s at 20° C.

The light-weight molding materials were evaluated in the same manner as in Example 1, and the obtained results are summarized in Table 3.

As readily understood from the results, when the mixing ratio of water to the viscosity adjusting agent is within the intended range, excellent fluidity and shape retentivity are provided, and the handling-ability is significantly improved.

TABLE 3

| | Example | Example | Example | Example | Example | Comparative | Comparative |
|---|---|---|---|---|---|---|---|
| | 12 | 13 | 14 | 15 | 16 | Example 5 | Example 6 |
| Light-weight | 6.2 | 6.2 | 6.2 | 6.2 | 6.2 | 6.2 | 6.2 |
| material | | | | | | | |
| (% by weight) | | | | | | | |
| Average particle | 35 | 35 | 35 | 35 | 35 | 35 | 35 |
| size of light- | | | | | | | |
| weight material | | | | | | | |
| (μm) | | | | | | | |
| Water | 87.6 | 85.7 | 81.7 | 75.7 | 69.7 | 87.7 | 64.7 |
| (% by weight) | | | | | | | |
| PVA | 6 | 6 | 6 | 6 | 6 | 6 | 6 |
| (% by weight) | | | | | | | |
| First viscosity | 0.1 | 2.0 | 6.0 | 12.0 | 18.0 | 0 | 23.0 |
| adjusting agent | | | | | | | |
| (% by weight) | | | | | | | |
| Second viscosity | 0.1 | 0.1 | 0.1 | 0.1 | 0.1 | 0.1 | 0.1 |
| adjusting agent | | | | | | | |
| (% by weight) | | | | | | | |
| Water/PVA | 14.6 | 14.3 | 13.6 | 12.6 | 11.6 | 14.6 | 10.8 |
| Water/ | 876.0 | 42.9 | 13.6 | 6.3 | 3.9 | — | 2.8 |
| first viscosity | | | | | | | |
| adjusting agent | | | | | | | |
| Ejection amount 1 | 4.8 | 3.8 | 3.4 | 3.0 | 2.4 | 7.4 | 1.5 |
| (cm³/10 seconds) | | | | | | | |
| Shape | Fair | Good | Very | Very | Good | Bad | Fair |
| | | | good | good | | | |
| Volume shrinkage | 25 | 26 | 26 | 26 | 27 | 25 | 28 |
| (%) | | | | | | | |
| Deformation | 280 | 450 | 440 | 440 | 400 | 120 | 300 |
| resistance | | | | | | | |
| (gf) | | | | | | | |
| Penetration test | 24 | 29 | 29 | 27 | 25 | 22 | 25 |
| (25° C./mm) | | | | | | | |
| Penetration test | 28 | 33 | 32 | 30 | 29 | 24 | 288 |
| (40° C./mm) | | | | | | | |
| Density (g/cm³) | 0.25 | 0.27 | 0.27 | 0.27 | 0.27 | 0.25 | 0.27 |

### Examples 17 to 20

In Examples 17 to 20, the amount and average particle size of the light-weight material, and the mixing ratios of the constituent materials were changed as shown in Table 4. The first viscosity adjusting agent was sodium dodecylbenzene sulfonate (abbreviated as DBS-Na), hydroxyethyl cellulose (HEC), a combination of methyl cellulose (MC) and potassium oleate (OK), or Cyamoposis Gum, and the second viscosity adjusting agent was glycerol. The physical properties of the resultant light-weight molding materials were compared with each other.

The PVA used herein was a moderate or high viscosity PVA, a 4% aqueous solution of which has a viscosity of 30 mPa·s or mPa·s at 20° C., respectively.

The light-weight molding materials were evaluated in the same manner as in Example 1, and the obtained results are summarized in Table 4.

As readily understood from the results, when the mixing ratio of water to the viscosity adjusting agent is within the intended range, excellent fluidity and shape retentivity are provided, and handling-ability is significantly improved.

TABLE 4

| | Example | Example | Example | Example |
|---|---|---|---|---|
| | 17 | 18 | 19 | 20 |
| Light-weight | 15.0 | 5.0 | 7.0 | 7.2 |
| material | | | | |
| (% by weight) | | | | |
| Average particle | 22 | 35 | 35 | 35 |
| size of light- | | | | |
| weight material | | | | |
| (μm) | | | | |
| Water | 66.0 | 91.0 | 76.0 | 82.3 |
| (% by weight) | | | | |
| PVA | 6.0 | 0.4 | 5.0 | 7.5 |
| (% by weight) | Moderate | High | Moderate | High |
| | viscosity | viscosity | viscosity | viscosity |
| First viscosity | 6.8 | 3.6 | 4.8 MC | 2 |
| adjusting agent | DBS/Na | HEC | 4.8 OK | Cyamoposis |
| (% by weight) | | | | Gum |
| Second viscosity | 6.2 | 0 | 0.1 | 1.0 |
| adjusting agent | | | | |
| (% by weight) | | | | |
| Water/PVA | 11.0 | 227.5 | 15.2 | 11.0 |
| Water/ | 11.4 | 25.3 | 7.9 | 82.3 |
| first viscosity | | | | |
| adjusting agent | | | | |
| Ejection amount 1 | 6.8 | 5.5 | 4.7 | 4.9 |
| (cm³/10 seconds) | | | | |
| Shape | Very | Good | Good | Very |
| | good | | | good |
| Volume shrinkage | 29 | 29 | 27 | 26 |
| (%) | | | | |
| Deformation | 910 | 340 | 670 | 490 |
| resistance | | | | |
| (gf) | | | | |
| Penetration test | 19 | 35 | 24 | 29 |
| (25° C./mm) | | | | |
| Penetration test | 24 | 43 | 29 | 35 |
| (40° C./mm) | | | | |
| Density (g/cm³) | 0.29 | 0.32 | 0.24 | 0.24 |

The light-weight molding material of the present invention is composed of a light-weight molding material and a viscosity adjusting agent, wherein the addition quantities of water and the light-weight material composing the light-weight molding material, and the mixing ratio of water to the polyvinyl alcohol resin are controlled to fall within the predetermined ranges. The light-weight molding material achieves good relationship between its squeezability through a decorating tip and antithetical properties such as shape retentivity without causing the above-described expansion problem.

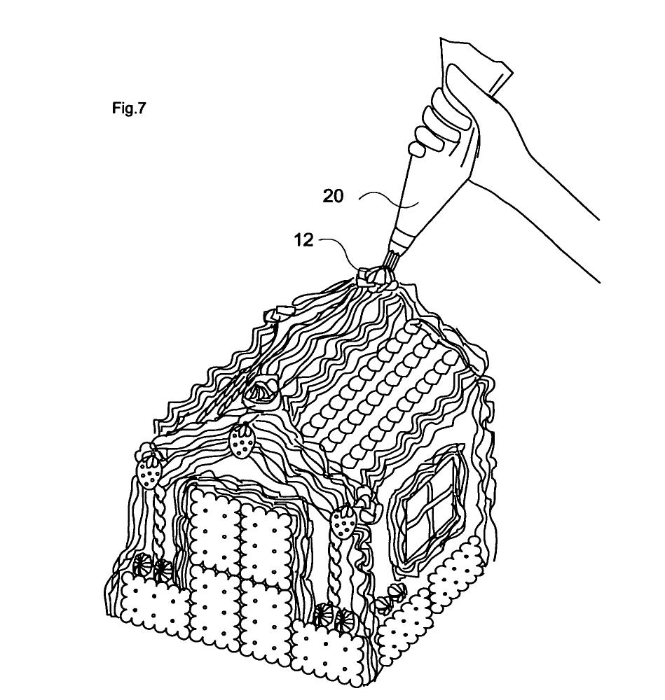

Accordingly, the light-weight molding material of the present invention is favorably used to make imitations of decorated cakes, cookie houses, confectionery, whipped creams, and the like as toys or ornaments, as shown in FIG. 7.

1-11. (canceled)

12. A light-weight molding material comprising a binder resin containing a polyvinyl alcohol resin, a viscosity adjusting agent, water, and a light-weight material, wherein an addition quantity of the light-weight material is adjusted to a value within the range of from 3 to 22% by weight with reference to the total amount, an addition quantity of the water is adjusted to a value within the range of from 65 to 92% by weight with reference to the total amount, and a mixing ratio of water to the polyvinyl alcohol resin is adjusted to a value within the range of from 3 to 300 by weight ratio.

13. The light-weight molding material according to claim 12, wherein an addition quantity of the polyvinyl alcohol resin as the binder resin is adjusted to a value within the range of from 0.2 to 22% by weight with reference to the total amount.

14. The light-weight molding material according to claim 12, wherein an addition quantity of the viscosity adjusting agent is adjusted to a value within the range of from 0.1 to 20% by weight with reference to the total amount, and a mixing ratio of water to the viscosity adjusting agent is adjusted to a value within the range of from 3 to 920 by weight ratio.

15. The light-weight molding material according to claim 12, wherein the viscosity adjusting agent is at least one compound selected from the group consisting of fatty acids, fatty acid salts, sulfonates, sulfate salts, and polysaccharides.

16. The light-weight molding material according to claim 15, which comprises the adjusting agent as the first viscosity adjusting agent, and further comprises a polyhydric alcohol as a second viscosity adjusting agent which is different from the first viscosity adjusting agent.

17. The light-weight molding material according to claim 12, wherein the penetration into the light-weight molding material measured according to JIS K 2207 is from 8 to 80 mm (measuring temperature: 25° C.).

18. The light-weight molding material according to claim 12, wherein the ejection amount of the light-weight molding material squeezed out using a squeezer (volume: 250 ml, decorating tip: polygonal, outside diameter: 17 mm, inside diameter: 13 mm) is adjusted to a value within the range of from 2 to 250 cm³ in 10 seconds.

19. The light-weight molding material according to claim 12, wherein a volume shrinkage of the light-weight molding material is adjusted to a value of 35% or less.

20. The light-weight molding material according to claim 12, wherein the light-weight material comprises both of organic microballoon and inorganic microballoon or each.

21. The light-weight molding material according to claim 12, wherein the light-weight molding material further comprises a coloring agent, and an addition quantity of the coloring agent is adjusted to a value within the range of from 0.01 to 10% by weight with reference to the total amount.

22. The light-weight molding material according claim 12, wherein the light-weight molding material is creamy, and when the light-weight molding material is squeezed out via a decorating tip having a predetermined shape, the predetermined shape formed by the decorating tip is maintained.
